(19) United States
(12) Patent Application Publication
(10) Pub. No.: US 2009/0066664 A1
(43) Pub. Date: Mar. 12, 2009

(54) TOUCH SCREEN AND DISPLAY METHOD THEREOF

(75) Inventors: SHIH-FANG WONG, Tu-Cheng (TW); XIN LU, Shenzhen City (CN); YU-CUI ZHOU, Shenzhen City (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/133,384

(22) Filed: Jun. 5, 2008

(30) Foreign Application Priority Data
Sep. 7, 2007 (CN) 200710201625.4

(51) Int. Cl. G06F 3/041

(52) U.S. Cl. 345/173

(57) ABSTRACT

A touch screen includes an information source, a display, a sensor module, an adjuster, and a processor. The information source is for providing display data, such as images or other documents, to be displayed. The display is for outputting the display data, and is overlaid with the sensor module. The sensor module is for sensing a touch action on a position thereon corresponding to the display data, and generating corresponding touch data. The adjuster is for generating adjusting commands. The processor is for adjusting the size of the display data according to the touch data and the adjusting commands.

### BACKGROUND

1. Field of the Invention

The present invention generally relates to display apparatuses and methods, and particularly to a display apparatus utilizing a touch screen and a display method thereof.

2. Description of Related Art

Currently, display apparatuses are widely used in electronic devices, such as computers, televisions, and personal digital assistants (PDAs), to output information. The display apparatuses display data such as images, videos, and so on. Many new functions, touch screen for example, are developed to facilitate use of the display apparatus.

Touch screens are provided in the display apparatuses to allow input without keyboards and mice. Therefore, by adopting the touch screens, some portable electronic devices, such as mobile phones and PDAs, can provide a comparative bigger display area because no need for keypads.

However, as the size of the portable electronic device gets smaller and smaller, the content of the displayed information becomes too small to identify. Moreover, images or other documents are sometimes larger than the display area such that the slide bar must be scrolled in order to view the entire contents.

Therefore, improvements for a touch screen and a display method are needed in the industry to address the aforementioned deficiency.

### SUMMARY

A touch screen includes an information source, a display, a sensor module, an adjuster, and a processor. The information source is for providing display data, such as images or other documents, to be displayed. The display is for outputting the display data, and is overlaid with the sensor module. The sensor module is for sensing a touch action on a position thereon corresponding to the display data, and generating corresponding touch data. The adjuster is for generating adjusting commands. The processor is for adjusting the size of the display data according to the touch data and the adjusting commands. A display method for the touch screen is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic, block diagram of a touch screen in accordance with an exemplary embodiment.

FIG. 2 is schematic diagram showing the user interface of the touch screen of FIG. 1.

FIG. 3 is a process flow diagram illustrating a display method in accordance with an exemplary embodiment.

### DETAILED DESCRIPTION

Reference will now be made to the drawings to describe a preferred embodiment of the touch screen and a preferred embodiment of the display method.

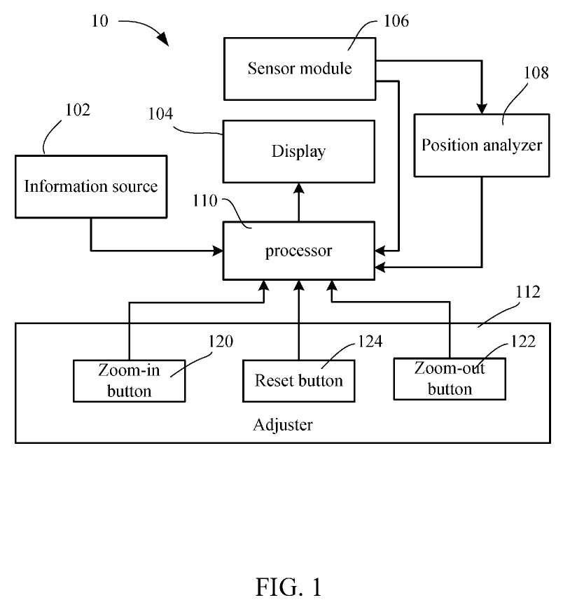

Referring to FIG. 1, a touch screen 10 in accordance with an exemplary embodiment includes an information source 102, a display 104, a sensor module 106, a position analyzer 108, a processor 110, and an adjuster 112. The information source 102 is used for providing display data such as images, documents, or videos. The display 104 is used for outputting the display data. The sensor module 106 overlaid with the display is configured for sensing whether the display 104 is touched at a predetermined position corresponding to the display data, generating touched data, and generating a cut-off signal when no longer touched. The position analyzer 108 is used for analyzing the touch data and generating a position signal indicating the predetermined position. The processor 110 is used for processing the display data, such as zooming in on or zooming out from images or videos, based on adjusting commands, and the processor 110 can also discontinue processing the display data when receiving the cut-off signal. The adjuster 112 is operated to generate the adjusting commands.

The adjuster 112 includes a zoom-in button 120, a zoom-out button 122, and a reset button 124. When pressed, the zoom-in button 120 generates a zoom-in command. The zoom-out button 122 is configured for generating a zoom-out command when pressed. The reset button 124 generates a reset command when pressed. The processor 110 will process the display data according to the commands. When the zoom-in command is received, the processor 110 zooms in on images or documents on the display 104. When the zoom-out command is received, the processor 110 zooms out from images or documents on the display 104. When the reset command is received, the processor 110 resets images or documents to default sizes on the display 104.

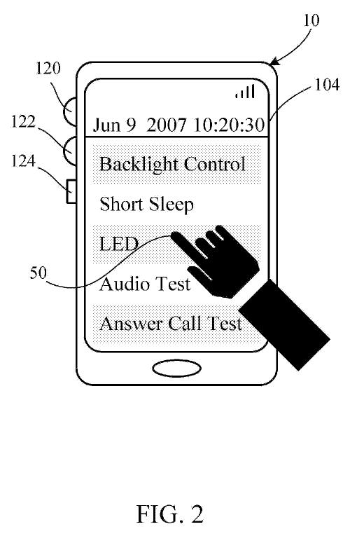

Also referring to FIG. 2, the zoom-in button 120, the zoom-out button 122, and the reset button 124 are configured on a side of the touch screen 10. Only one button can be pressed at a time. The display 104 is overlaid with the sensor module 106. When a position 50 on the display 104 is touched to select an item, such as item LED, the sensor module 106 generates touch data corresponding to the touch action. The position analyzer 108 analyzes the touch data and generates a position signal indicating the position 50. The processor 110 processes images or documents according to the item LED based on a default size and the position signal. The display 104 displays the images or documents with the default size around the position 50.

When the zoom-in button 120 is pressed, the processor 110 zooms in on the images or documents around the position 50 based on the zoom-in command from the zoom-in button 120. When the zoom-out button 122 is pressed, the processor 110 zooms out from the images or documents around the position 50 of the display 104 based on the zoom-out command from the zoom-out button 120. When the reset button 124 is pressed, the processor 110 resets the images or documents to the default size around the position 50. When the display 104 is no longer touched, the sensor module 106 generates the cut-off signal and the processor 110 discontinues zooming in on or zooming out from the images or documents when receiving the cut-off signal.

As mentioned above, the touch screen 10 provides three buttons to adjust sizes of images or documents around the position touched. It is convenient to discontinue adjusting the sizes by removing the touch tools, such as a stylus.

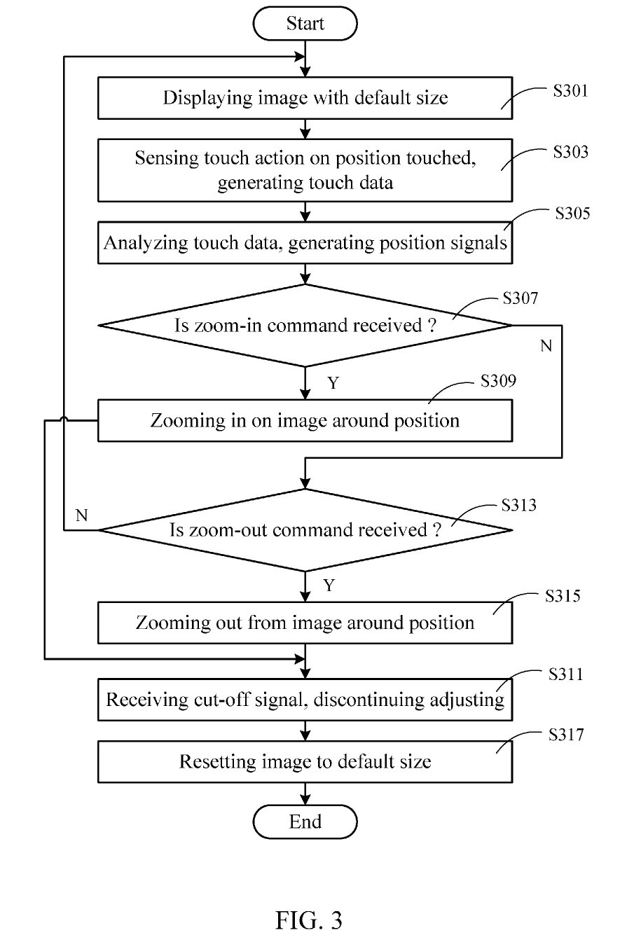

Referring to FIG. 3, a display method for displaying adjustable image in the touch screen 10 in accordance with an exemplary embodiment includes the following steps.

In step S301, the display 104 displays an image with a default size around a position touched.

In step S303, the sensor module 106 senses a touch action on the position touched, and generates touch data.

In step S305, the position analyzer 110 analyzes the touch data and generates position signals.

In step S307, the processor 110 identifies whether a zoom-in command is received. If the zoom-in command is received, the procedure goes to step S309. If the zoom-in command is not received, the procedure goes to step S313.

In step S309, the processor 110 zooms in on the image around the touched position based on the zoom-in command and the position signals.

In step S311, the processor 110 receives a cut-off signal, and discontinues adjusting the image.

In step S313, the processor 110 identifies whether a zoom-out command is received. If the zoom-out command is received, the procedure goes to step S315. If the zoom-out command is not received, the procedure goes to step S301.

In step S315, the processor 110 zooms out from the image around the touched position based on the zoom-out command and the position signals, and then the procedure goes to step S311.

In step S317, the processor 110 resets the images to the default size.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A touch screen comprising:
an information source for providing display data;
a display for outputting the display data;
a sensor module, with which the display is overlaid, for sensing a touch action on a position thereon corresponding to the display data, and generating corresponding touch data;
an adjuster for generating adjusting commands; and
a processor for adjusting the size of the display data according to the touch data and the adjusting commands.

2. The touch screen according to claim 1, further comprising a position analyzer for analyzing the touch data, generating a position signal indicating the position, and sending the position signal to the processor.

3. The touch screen according to claim 1, wherein the adjuster comprises a zoom-in button configured on a side of the touch screen, and the zoom-in button is configured for generating a zoom-in command to signal the processor to zoom in on the display data when the zoom-in button is pressed.

4. The touch screen according to claim 1, wherein the adjuster comprises a zoom-out button configured on a side of the touch screen, and the zoom-in button is configured for generating a zoom-out command to signal the processor to zoom out from the display data when the zoom-out button is pressed.

5. The touch screen according to claim 1, wherein the adjuster comprises a reset button configured on a side of the touch screen, and the reset button is configured for generating a reset command to signal the processor to reset the display data to a default size when the reset button is pressed.

6. The touch screen according to claim 1, wherein the sensor module generates a cut-off signal to signal the processor to discontinue adjusting the size of the display data when the touch action is stopped.

7. A display method comprising:
displaying an image in a default size around a touched position;
sensing a touch action on the touched position, and generating touch data;
analyzing the touch data to generate position signals;
identifying whether a zoom-in command is received; and
zooming in on the image around the touched position based on the zoom-in command and the position signals if the zoom-in command is received.

8. The display method according to claim 7, further comprising:
receiving a cut-off signal;
discontinuing zooming in on the image.

9. The display method according to claim 7, further comprising:
identifying whether a zoom-out command is received if the zoom-in command is not received;
zooming out from the image around the touched position based on the zoom-out command and the position signals if the zoom-out command is received.

10. The display method according to claim 9, further comprising:
going to step “displaying an image in a default size around a touched position” if the zoom-out command is not received.

11. The display method according to claim 9, further comprising:
receiving a cut-off signal;
discontinuing zooming out from the image.
